(19) United States
(12) Patent Application Publication
(10) Pub. No.: US 2014/0034799 A1
(43) Pub. Date: Feb. 6, 2014

(54) ADJUSTABLE SUPPORT BRACKET

(71) Applicant: Mediamounts, Ltd., Cambridge (CA)

(72) Inventors: Simon Fallows, Cambridge (CA); Nicholas Leonard Blackburn, Wellesley (CA)

(73) Assignee: Mediamounts, Ltd., Cambridge (CA)

(21) Appl. No.: 14/048,294

(22) Filed: Oct. 8, 2013

Related U.S. Application Data
(63) Continuation-in-part of application No. 13/080,069, filed on Apr. 5, 2011.

(51) Int. Cl. F16M 13/02

(52) U.S. Cl. CPC F16M 13/022
USPC 248/297.21

(57) ABSTRACT

A height-adjustable support system including a vertically elongated support track having a top end and a bottom end and a plurality of parallel channels extending therebetween, a carriage assembly having a support surface and channel engaging members wherein said carriage assembly is adapted to be retained by said channels and slide along said channels, said carriage assembly including a support plate adapted to support a computer monitor and a keyboard support, and an actuator assembly being operable to releasably retain said carriage assembly along said support track.

### CROSS-REFERENCE TO RELATED APPLICATION

This application is a continuation-in-part of and claims the benefit of co-pending U.S. patent application Ser. No. 13/080,069, which was filed Apr. 5, 2011, the disclosure of which is hereby incorporated by reference in its entirety.

### FIELD OF THE INVENTION

The present invention relates to a support apparatus and more particularly an adjustable support bracket for height adjustably supporting a display device and input apparatus.

### BACKGROUND OF THE INVENTION

In order to maximize accurate and convenient data input and retrieval, it has become common for industries and particularly the hospital industry to have computer terminals located at various locations throughout the building instead of a dedicated office or desk. These locations include hallways and patient rooms as well as offices so that these terminals or workstations can be used by various individuals on different shifts. Few, if any of the workstations are dedicated to an individual user. Therefore, instead of having office space dedicated to a single user and workstation, the workstations are placed where they are accessible by staff as needed and are usually accessed from a standing position.

Therefore it is important to have a workstation that does not take up much space and accommodates frequent use for short periods at a time. Furthermore, since users come in a variety of heights, it is necessary that the support bracket for the workstation be vertically adjustable. It is also desirable that the workstation when not in use takes up as little space as possible and can be retracted to avoid being bumped by carts or passersby. The invention as described herein addresses these issues and provides advantageous solutions.

### OBJECTS AND SUMMARY OF THE INVENTION

One object of the invention is to provide a mounting bracket for a supporting a monitor and a keyboard.

Another object of the invention is to provide mounting bracket having a track for attachment to a vertical wall or post.

Yet another object of the invention is to provide a height-adjustable monitor support for slidably engaging the track.

Still another object of the invention is to provide mounting bracket having a keyboard support.

Yet another object of the invention is to provide an autoflip rotatable keyboard support.

It must be understood that no one embodiment of the present invention need include all of the aforementioned objects of the present invention. Rather, a given embodiment may include one or none of the aforementioned objects. Accordingly, these objects are not to be used to limit the scope of the claims of the present invention.

In summary the present invention is directed to an adjustable support member for mounting a device, comprising a vertically elongated support track having a top end and a bottom end and a plurality of parallel channels extending between said top end and said bottom end and a carriage assembly having a support surface and channel engaging members wherein said carriage assembly is adapted to be retained by said channels and slide along said channels and an actuator assembly being operable to releasably retain said carriage assembly in a fixed position relative to said support track.

The present invention is further directed to a height-adjustable support system, comprising a vertically elongated mounting bracket adapted to be attached to a support surface and said mounting bracket including a vertically elongated support track having a top end and a bottom end and a plurality of parallel channels extending between said top end and said bottom end and a carriage assembly having a support surface and channel engaging members wherein said carriage assembly is adapted to be retained by said channels and slide along said channels and said carriage assembly including a support plate adapted to support a computer monitor and said carriage assembly further including a keyboard support and an actuator assembly being operable to releasably retain said carriage assembly in a fixed position relative to said support track.

The present invention is still further directed to an adjustable support bracket for mounting a device, including a vertically elongated support track having a plurality of parallel channels extending vertically, a carriage assembly having a support surface and channel engaging members wherein said carriage assembly is retained by and slidable along said channels, an actuator assembly including a gas spring assembly that includes a valve, wherein said gas spring assembly releasably retains said carriage assembly at desired locations along said support track, and said actuator assembly further includes a lever that is connected to a rod having an actuator trigger operatively connected to the valve of said gas spring assembly, wherein the lever is movable to open and close said valve.

The present invention also is directed to a height-adjustable support system, including a vertically elongated support track having a top end and a bottom end and a plurality of parallel channels extending between said top end and said bottom end, a carriage assembly having a support surface and channel engaging members wherein said channel engaging members of said carriage assembly are retained by and slidable along said channels of said support track, said carriage assembly including a support plate spaced apart from and being positioned above a keyboard support, an actuator assembly including a movable rod having an actuator trigger at one end and being pivotally connected to an actuator lever at an opposed end, the actuator trigger being connected to a valve of a gas spring assembly that is connected at a first end to said support track and at a second end to said carriage assembly, and wherein said actuator assembly releasably retains said carriage assembly at positions along said support track.

The present invention is further directed to a spring-biased keyboard support, comprising a substantially flat keyboard support surface and a spring-biased hinge connected to said keyboard support surface and to a second support surface whereby said spring-biased hinge operates to automatically flip said keyboard support surface upright.

### BRIEF DESCRIPTION OF THE DRAWINGS

FIG. 1 is a perspective view of the adjustable support bracket;

FIG. 2 is an exploded view of the adjustable support bracket of FIG. 1;

FIG. 3 is a rear perspective view of the track extrusion;

FIG. 4 is a front perspective view of the track extrusion;

FIG. 5 is a top view of the track extrusion of FIGS. 3 and 4;

FIG. 6 is a rear perspective view of the carriage assembly;

FIG. 7 is a perspective view of the actuator assembly;

FIG. 8 is enlarged view of the actuator trigger block of FIG. 7;

FIG. 9 is an enlarged view of the actuator chassis of FIG. 7;

FIG. 10 is a perspective view of the actuator trigger;

FIG. 11 is a perspective view of the lever;

FIG. 12 is a perspective view of the autoflip keyboard support; and,

FIG. 13 is an exploded view of the autoflip keyboard support of FIG. 12.

FIG. 14 is a perspective view of a second example adjustable support bracket;

FIG. 15 is a front exploded perspective view of the adjustable support bracket of FIG. 14, without the wallmount plate used to connect to a wall;

FIG. 16 is a rear perspective view of the carriage assembly;

FIG. 17 is a top view of the track extrusion of adjustable support bracket of FIG. 14;

FIG. 18 is a rear exploded perspective view of the track extrusion and wallmount plate of the adjustable support bracket of FIG. 14;

FIG. 19 is a front perspective view of the actuator assembly of the adjustable support bracket of FIG. 14;

FIG. 20 is a rear perspective view of the actuator assembly of the adjustable support bracket of FIG. 14;

FIG. 21 is a rear exploded perspective view of the actuator assembly of the adjustable support bracket of FIG. 14;

FIG. 22 is a front perspective view of the autoflip keyboard support of the adjustable support bracket of FIG. 14;

FIG. 23 is a rear perspective view of the autoflip keyboard support shown in FIG. 22; and,

FIG. 24 is a front exploded perspective view of the autoflip keyboard support shown in FIG. 22.

### DETAILED DESCRIPTION OF THE PREFERRED EMBODIMENT

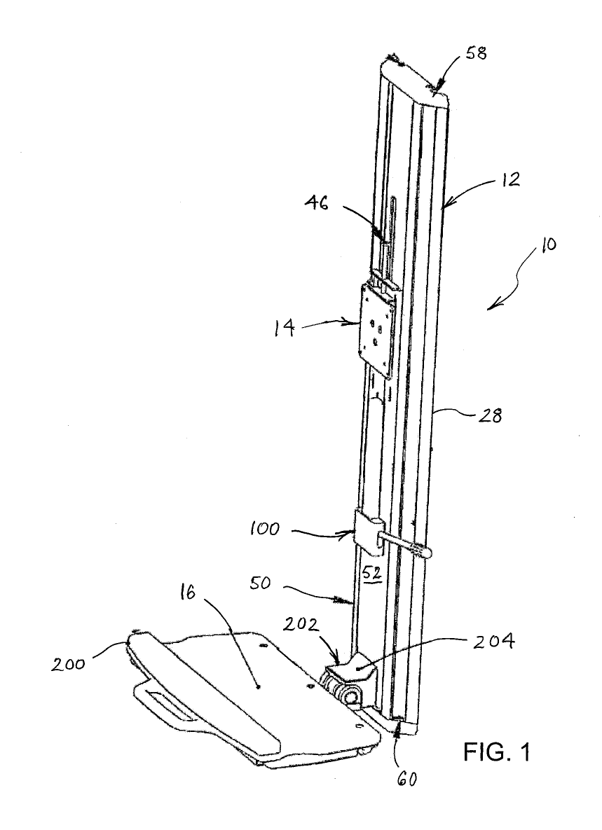

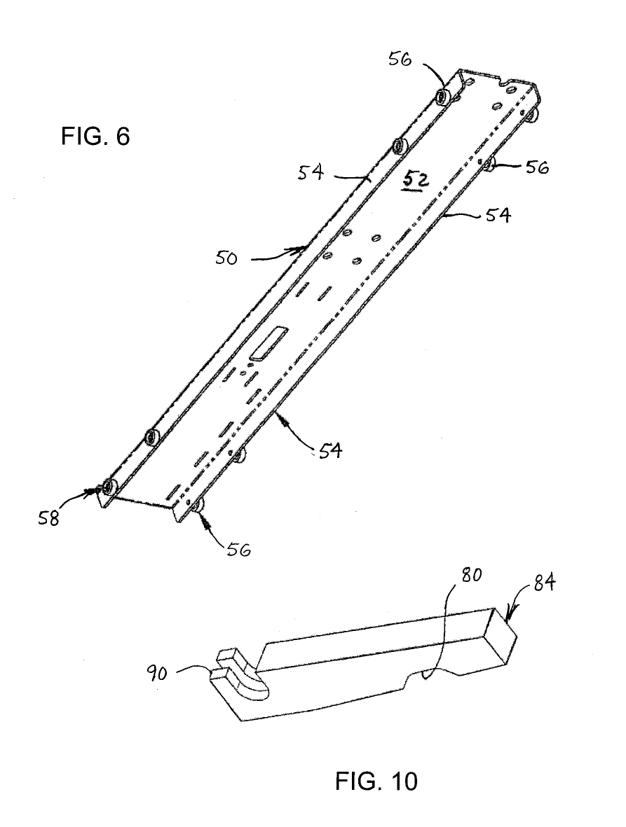

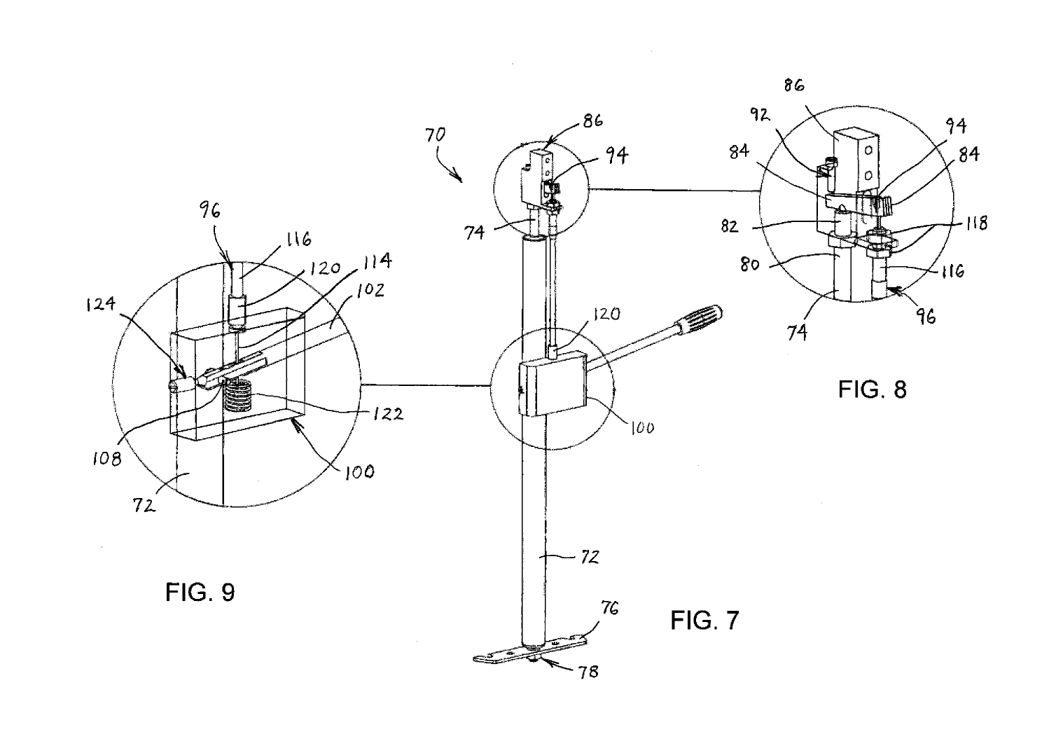

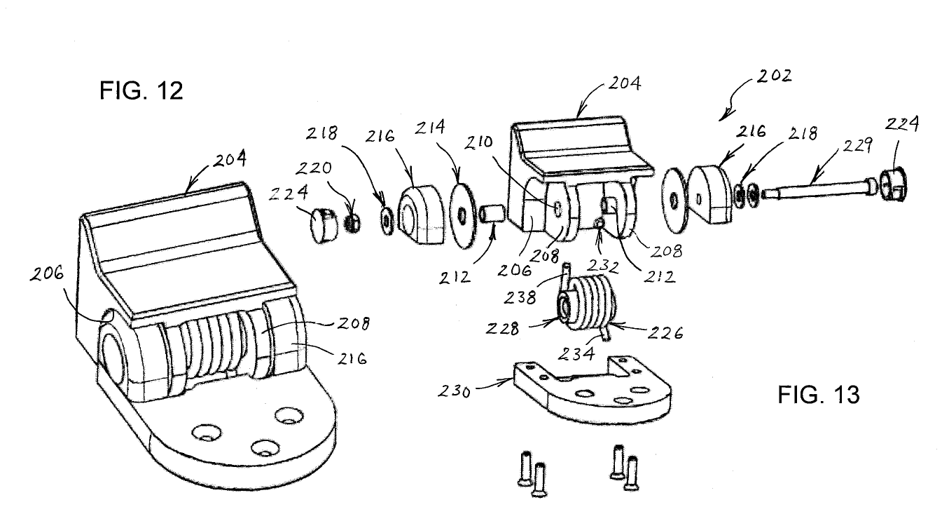

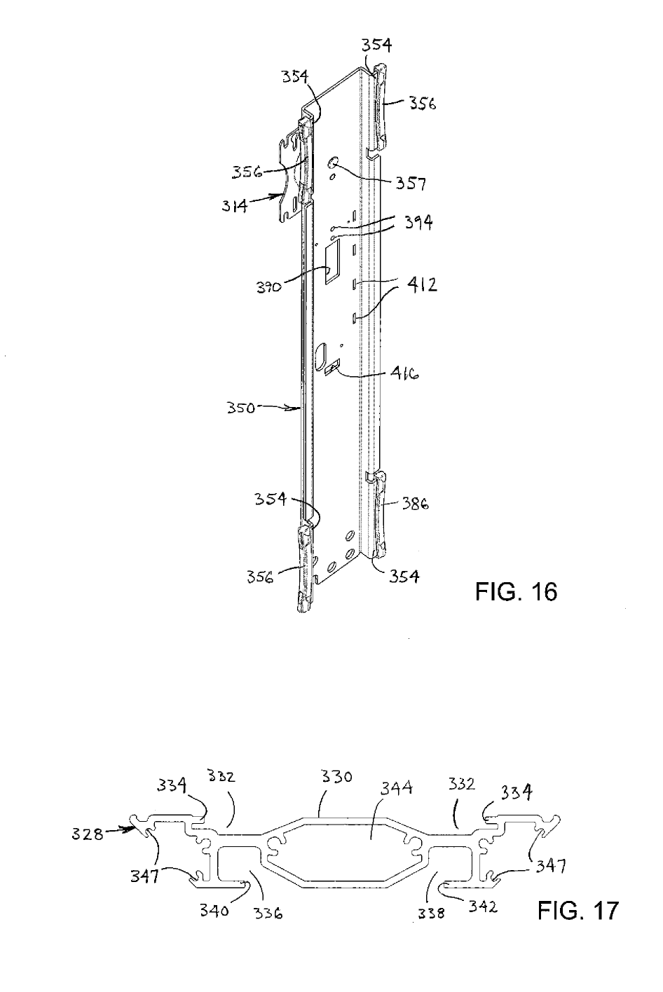

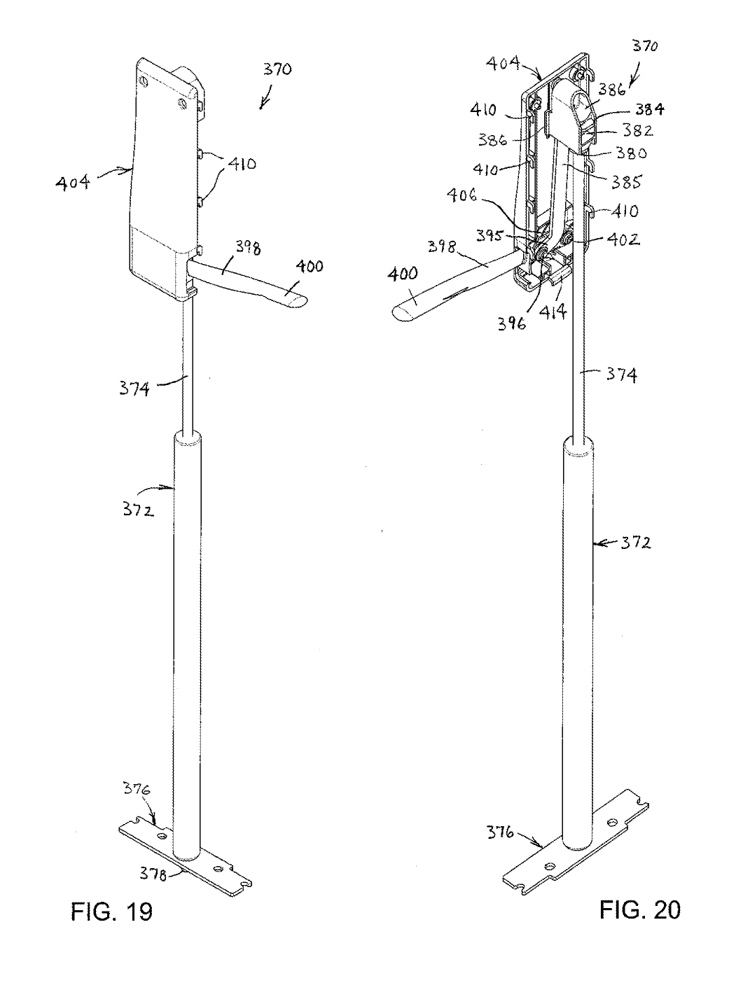

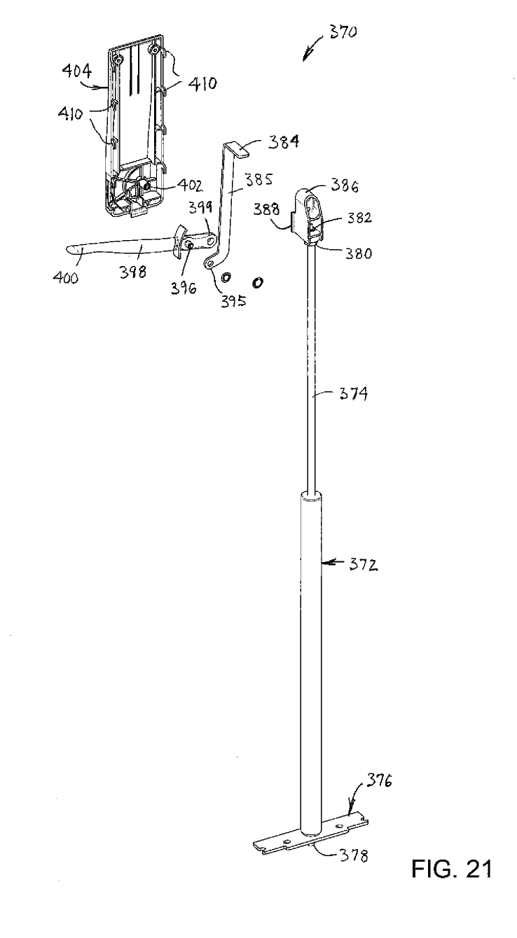

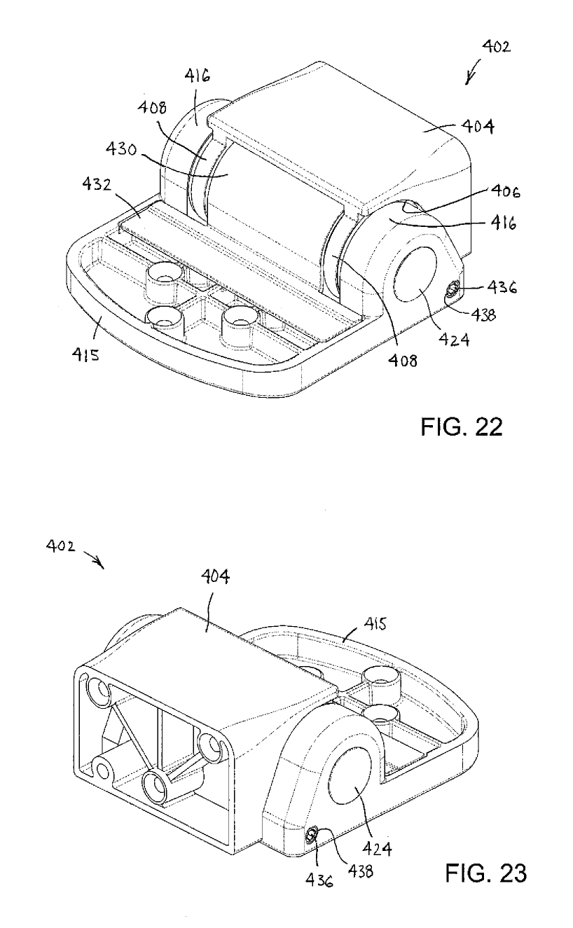

The preferred forms of the invention will now be described with reference to two example embodiments, shown in FIGS. 1-13 and 14-24, respectively. The appended claims are not limited to the preferred forms and no term and/or phrase used herein is to be given a meaning other than its ordinary meaning unless it is expressly stated otherwise.

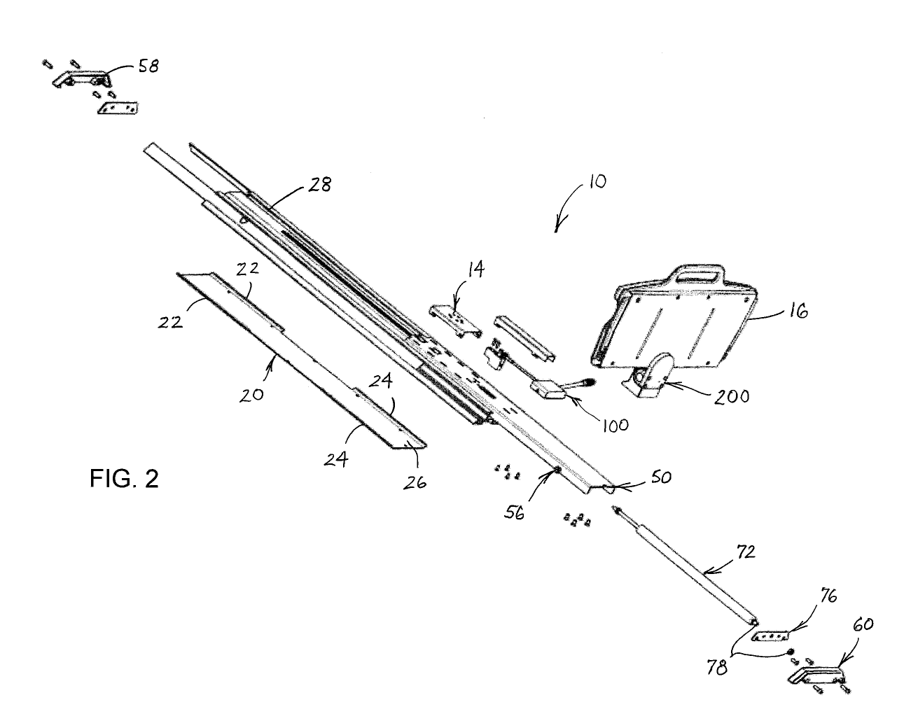

In FIG. 1, a mount or adjustable support bracket 10 is shown having an elongated vertical section 12 having a plate 14 for attachment to a computer monitor or the like (not shown) and a horizontally extending surface 16 suitable for supporting a computer keyboard (also not shown). Now with reference the exploded view of FIG. 2, the mount or adjustable support bracket 10 includes a wallmount plate 20 which is designed to be fixedly secured by conventional fasteners to a vertical surface such as a wall or post. The wallmount plate 20 is preferably formed of substantially rigid material, preferably aluminum and is generally flat. The wallmount plate 20 includes pairs of upper and lower flanges 22 and 24 extending outwardly from the main body 26.

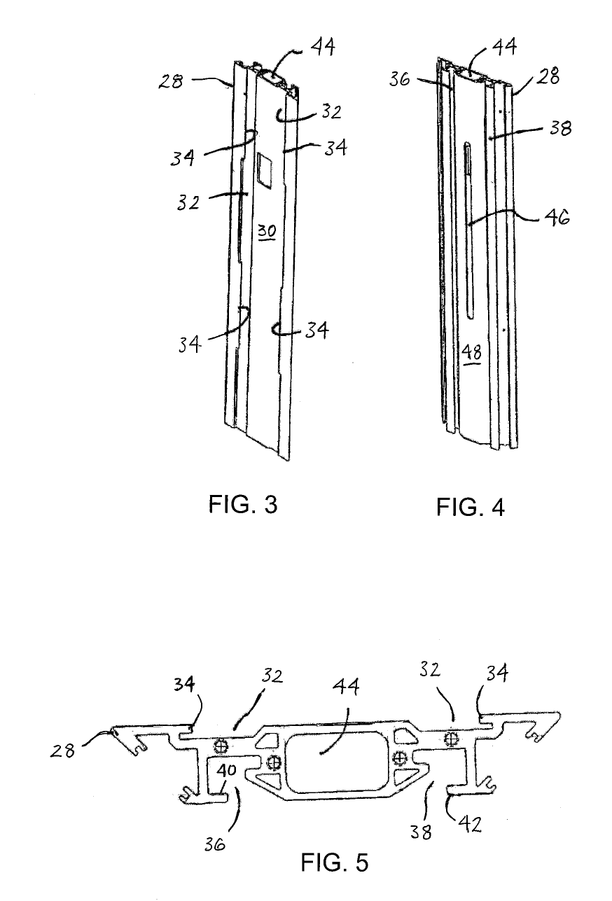

A track extrusion 28 formed of rigid material and preferably aluminum is shown in FIGS. 1, 2, 3, 4 and 5. Looking at the rear wall 30 of the track extrusion 28 in FIG. 3, a pair of recesses 32 is formed and extends the length of the extrusion 28. Four flanges 34 extend from the recesses 32 and engage wallmount flanges 22 and 24 when the track extrusion 28 is connected to the wallmount plate 20. Track extrusion 28 as seen in FIG. 4 includes a pair of channels 36 and 38 extending vertically preferably the entire length of track extrusion 28. As shown in FIG. 5, channels 36 and 38 each include a slot-forming flange or rail 40, 42 respectively. Track extrusion 28 also includes a central tube 44 extending the length of the track extrusion 28. A slot 46 is formed on front wall 48.

A carriage assembly 50 is moveably mounted to the track extrusion 28. As shown in FIGS. 1, 2, and 6, carriage assembly 50 includes a generally elongated front flat surface 52 and carriage roller wheel supporting strips 54 on each side of the front flat surface 52. The carriage roller wheels 56 are retained on the supporting strips 54 by shoulder bolts 58.

The carriage assembly 50 is mounted to the track extrusion 28 by inserting roller wheels 56 into channels 36 and 38. The roller wheels are then retained in channels 36 and 38 by flanges 40 and 42 respectively, but are free to roll within the channels.

A pair of end caps 58 and 60 joins the wallmount plate 20 and the track extrusion 28 together and keeps them from sliding relative to each other. End caps 58 and 60 also provide stops for the carriage assembly 50 and keep it from rolling out of the channels 36 and 38.

Now the actuator assembly 70 will be described with respect to FIGS. 1, 2, 7, 8 and 9. The actuator assembly 70 preferably includes a gas spring cylinder 72 having a gas spring rod 74. The gas spring cylinder 72 is mounted to a footing plate 76 preferably by a threaded fastener assembly 78. The footing plate 76 is attached at the foot 78 of the track extrusion 28 and is covered by end cap 60. The gas spring cylinder 72 extends into the central tube 44 of the track extrusion.

At the top 80 of the gas spring rod is a valve 82 which allows air into and out of the gas spring cylinder 72. Operation of the valve 82 is accomplished by movement of an actuator trigger 84 held within the actuator trigger block 86. The actuator trigger block 86 is connected by conventional screws to the flat front surface 52 of the carriage assembly 50. The actuator trigger 84 as shown in FIG. 10 is generally rectangular and has a recess 88 on the bottom thereof and a U-shaped forked slot 90 on one end. The recess 88 engages the valve 82 to limit airflow and when the trigger 84 is released air is allowed to flow into or out of the valve 82. A trigger pivot screw 92 is provided to adjust the degree of movement of the trigger 84. The U-shaped forked slot 90 receives the top end 94 of pull cable 96. Pull cable 96 extends downwardly from the trigger block 86 to actuator lever chassis 100.

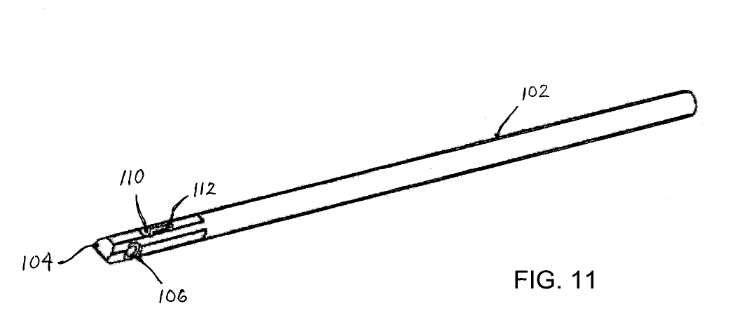

Actuator chassis 100 includes a lever 102. Lever 102 as shown in FIG. 11 includes a chiseled end 104. Spaced from chiseled end 104 is a horizontal opening 106 for receiving a pivot pin 108. Pivot pin 108 is fixed to the actuator chassis 100 and retains the lever 102 within the chassis 100. Spaced from horizontal opening 106 is a round vertical opening 110 having a slot 112 extending along the lever 102 away from chiseled end 104. Opening 110 and slot 112 are adapted to receive and retain the second end 114 of the pull cable 96. Pull cable 96 includes an outer housing 116 which includes upper fasteners 118 and lower fastener 120 to connect the housing 116 to the trigger block 86 and the actuator chassis 100. A compression spring 122 is located within the actuator chassis 100 and operates to bias the lever 102 upwardly. A plunger screw 124 operates to engage the chiseled end 104 of the lever 102 to limit movement of the lever 102. When the plunger screw 124 is backed off, the lever 102 is free to rotate.

Now with reference to FIGS. 1, 2, 12 and 13 the auto flip keyboard support assembly will be described. Preferably at the flat front surface 52 of the carriage assembly 50, a keyboard support assembly 200 is mounted. The keyboard support 200 is attached to an auto flip chassis 202 having a base member 204 for attachment to the flat front surface 52. The base member 204 includes an arcuate base wall 206 having a pair of spaced apart circular flanges 208 extending therefrom. Each of the flanges 208 includes a central opening 210 for receiving preferably a brass bushing 212. On each outer side of the circular flanges 208 are preferably fastened a nylon washer 214, a pivot lobe 216, an SAE washer 218, and a pair of bore caps 224. Located between the circular flanges 208 is a torsion spring 226 and an alignment bushing 228. A shoulder bolt 229 passes through these parts and is connected to a nylock nut 220 to hold the parts together. A keyboard attachment plate 230 is preferably screwed to the pivot lobes 216. A set screw 232 is attached to the base member 204 and engages a first arm 234 of the torsion spring 226. A second arm 238 of the torsion spring engages the keyboard plate 230 so that the spring can cause rotation of the keyboard plate 230 relative to the base member. The set screw 232 can be adjusted so that tension on the torsion spring 226 can be increased or decreased.

In operation, the actuator assembly 70 permits vertical adjustment of the plate 14 and the keyboard support assembly 200 in a single handed motion vertically by moving the lever 102 downwardly which causes pull cable 96 to move actuator trigger 84 and open valve 82 of the gas spring cylinder 72. Once the valve 82 is opened, the carriage assembly 50 can be slid upward or downward. To lock the carriage assembly 50 in a desired position, the lever 102 is simply released and valve 82 is closed by the actuator trigger 84.

It should be understood that the rigid materials used in the manufacture of the mount or adjustable support bracket 10 unless specifically identified can be aluminum or other suitably rigid materials such as other metals or plastics.

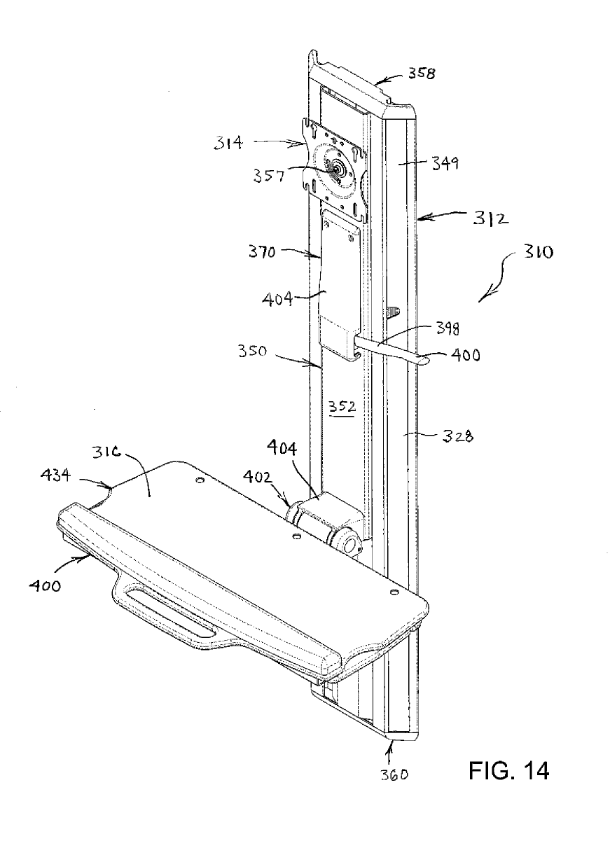

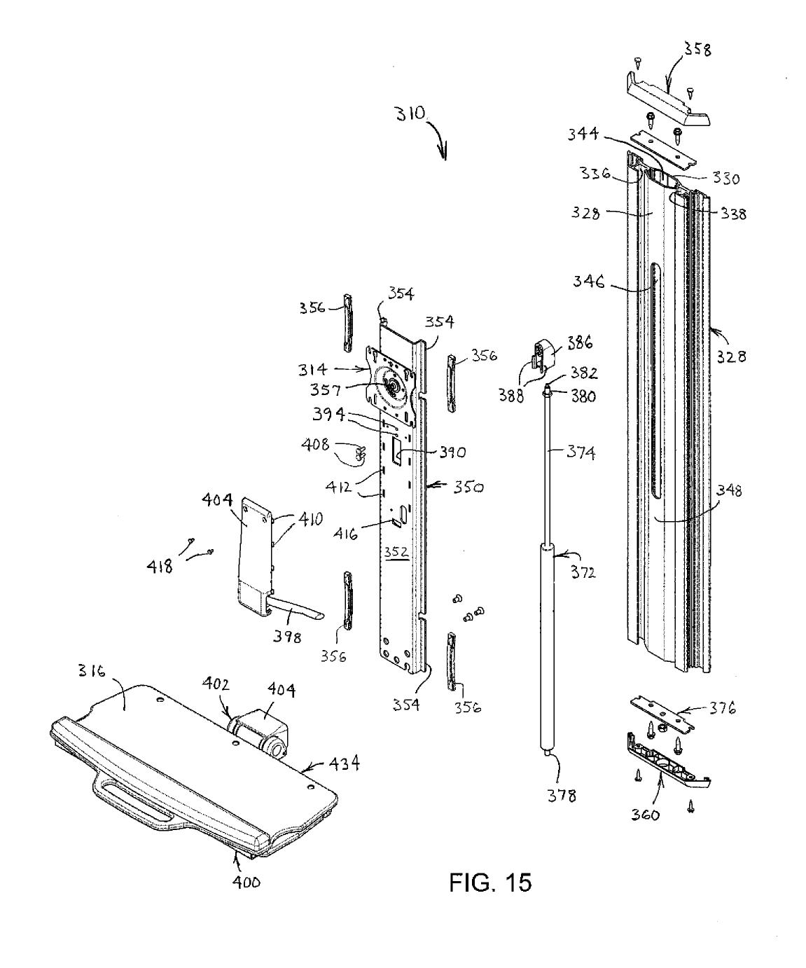

A second preferred form of the invention will now be described with reference to FIGS. 14-24.

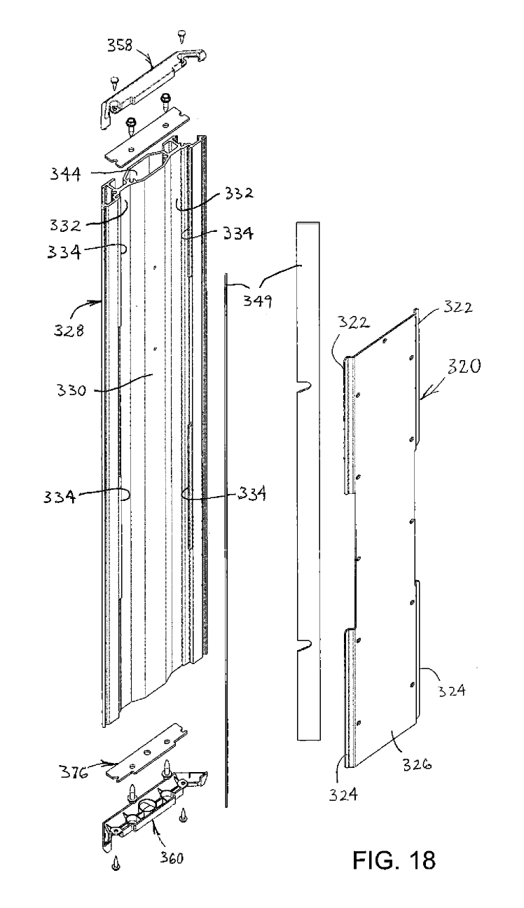

In FIG. 14, an adjustable support bracket 310 is shown having an elongated vertical section 312 having a plate 314 for attachment to a computer monitor or the like (not shown) and a horizontally extending surface 316 suitable for supporting a computer keyboard (also not shown). Now with reference the exploded views of FIGS. 15 and 18, the adjustable support bracket 310 includes a wallmount plate 320 which is designed to be fixedly secured by conventional fasteners to a vertical surface such as a wall or post. The wallmount plate 320 is preferably formed of substantially rigid material, preferably aluminum or other suitable material and is generally flat. The wallmount plate 320 includes pairs of upper and lower flanges 322 and 324, respectively, extending outwardly from a main body 326.

A track extrusion 328 formed of rigid material and preferably aluminum or other suitable material is shown in FIGS. 14, 15, 17 and 18. Looking at the rear wall 330 of the track extrusion 328, in FIGS. 17 and 18, a pair of recesses 332 is formed and extends the length of the extrusion 328. Four flanges 334 extend from the recesses 332 and engage wallmount flanges 322 and 324 when the track extrusion 328 is connected to the wallmount plate 320. Track extrusion 328 as seen in FIGS. 15 and 17 includes a pair of channels 336 and 338 extending vertically preferably the entire length of track extrusion 328. As shown in FIG. 17, channels 336 and 338 each include a slot-forming flange or rail 340, 342 respectively. Track extrusion 328 includes a central tube 344 extending the length of the track extrusion 328. A slot 346 is formed through a front wall 348. Opposed channels 347 of the track extrusion 328 receive covers 349 for a more finished appearance.

A carriage assembly 350 is moveably mounted to the track extrusion 328. As shown in FIGS. 14 and 15, carriage assembly 350 includes a generally elongated front flat surface 352 and carriage bushing supporting strips 354 on each side of the front flat surface 352. The carriage bushings 356 are retained on the bushing supporting strips 354 by friction and by being located within the channels 336 and 338. The plate 314 also is pivotally connected at post 357 to the carriage assembly 350.

The carriage assembly 350 is mounted to the track extrusion 328 by inserting the carriage bushings 356 on the bushing supporting strips 354 into channels 336 and 338. The carriage bushings 356 are then retained in channels 336 and 338 by flanges 340 and 342, respectively, but are free to slide within the channels 336 and 338.

A pair of end caps 358 and 360 joins the wallmount plate 320 and the track extrusion 328 together and keeps them from sliding relative to each other. End caps 358 and 360 also provide stops for the carriage assembly 350 and keep it from sliding out of the channels 336 and 338.

An actuator assembly 370 will be described with respect to FIGS. 14 and 19-21. The actuator assembly 370 preferably includes a gas spring cylinder 372 having a gas spring rod 374. The gas spring cylinder 372 is mounted to a footing plate 376 preferably by a threaded fastener assembly 378. The footing plate 376 is attached at the foot of the track extrusion 328 and is covered by end cap 360. The gas spring cylinder 372 extends into the central tube 344 of the track extrusion 328.

At the top 380 of the gas spring rod 374 is a valve 382 which allows air into and out of the gas spring cylinder 372. Operation of the valve 382 is accomplished by movement of an actuator trigger 384 at the upper end of a flat rod 385 that is slidably held by an actuator trigger block 386. The actuator trigger block 386 is efficiently connected to the carriage assembly 350. The actuator trigger block 386 has flanges 388 that extend outwardly. The actuator trigger block 386 is inserted rearwardly through an aperture 390 in the carriage assembly 350 until the flanges 388 engage the front surface 352 thereof. Fasteners 392, such as screws, rivets or other suitable fastening means, then are passed through apertures 394 in the carriage assembly 350. The trigger block 386 extends through the slot 346 in the front wall 348 of the track extrusion 328 where it is connected to the gas spring rod 374 of the gas spring cylinder 372 that is located within the central tube 344 of the track extrusion 328.

The components of the actuator assembly 370 are best seen in FIGS. 15 and 19-21. The rod 385 of the actuator assembly 370 is pivotally connected at its opposite end 395 to a post 396 on a lever 398. The lever 398 has a handle 400 at one end for grasping by a user and the opposite end 399 is pivotally connected to a post 402 on the rear of a lever chassis 404. The posts 396 and 402 are spaced apart, such that pivotal movement of the lever 398 drives the rod 385 up or down. A biasing member 406 biases the lever 398 upwardly to a position that closes the valve 382. The lever chassis 404 is connected to the carriage assembly 350 by fasteners 408, such as conventional screws, rivets or other suitable means of connection. The lever chassis 404 has rearward and downward extending bayonet type hooks 410 that are inserted into slots 412 in the front surface 352 of the carriage assembly 350, while a lower flange 414 on the lever chassis 404 is inserted into a further slot 416 in the face 352 of the carriage assembly 350. The lever chassis 404 then is moved downward to engage the hooks 410 and lower flange 414 with the carriage assembly 350. Fasteners 418, such as screws, rivets or other suitable fastening means are then used to fix the lever chassis 404 in a position connected to the carriage assembly 350.

Now with reference to FIGS. 14 and 22-24 an auto flip keyboard support assembly will be described. Preferably at the flat front surface 352 of the carriage assembly 350, a keyboard support assembly 400 is connected. The keyboard support assembly 400 is attached to an auto flip chassis 402 having a base member 404 for attachment to the flat front surface 352. The base member 404 includes an arcuate base wall 406 having a pair of spaced apart circular shaped flanges 408 extending therefrom. Each of the flanges 408 includes a central opening 410 for receiving preferably a bushing 412. The bushing 412 includes a washer portion 414 that contacts the outer side of the flange 408. A keyboard plate 415 includes a pair of pivot lobes 416. The keyboard plate 415 is connected to the base member 404 by using shoulder bolt 417, washers 418, and a nylock nut 420. The head of the bolt 417 and nut 420 are covered, respectively, by a pair of bore caps 424.

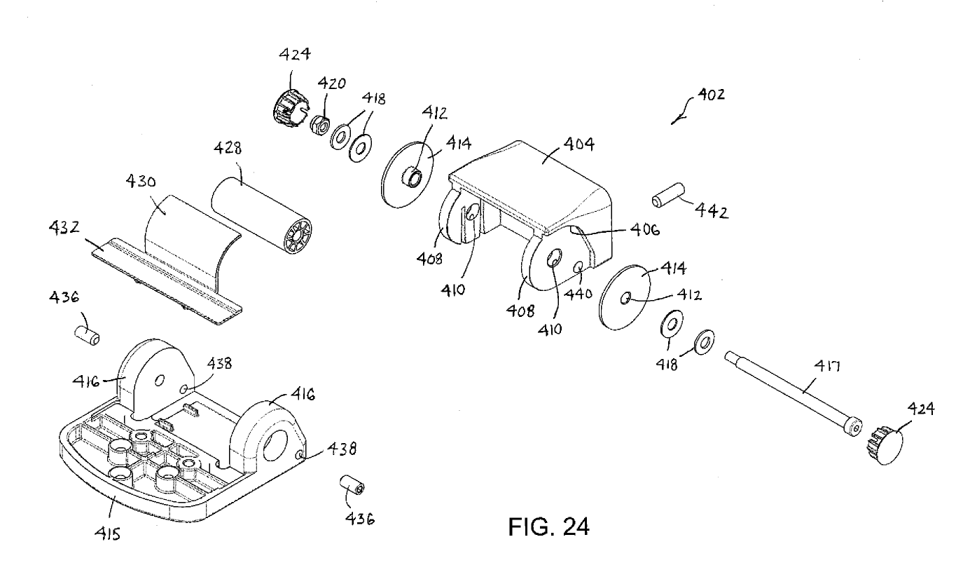

Located between the flanges 408 is an alignment bushing 428 that is received through the center of a torsion spring. The torsion spring is not shown in FIG. 24 but may be similar to the torsion spring 226 of the first example embodiment. An arm of the torsion spring engages the keyboard plate 415 to cause rotation of the keyboard plate 415 relative to the base member 404. A cover 430 fits over the torsion spring and alignment bushing 428 and includes a flange 432 by which the cover 430 is held in place when the base member 404 is connected to a keyboard support tray 434. A pair of set screws 436 is attached to the keyboard plate 415 in threaded bores 438 and may be rotated to advance inward and engage apertures 440 in the flanges 408 in the base member 404. Optionally, a set screw 442, such as the set screw 232 from the first example embodiment, engages an arm of the torsion spring and may be used to adjust the tension of the torsion spring, as desired. The base member 404 is connected to the carriage assembly 350, and the keyboard support tray 434 is connected to the keyboard plate 415, by fasteners, such as screws or other suitable fastening means.

In operation, the actuator assembly 370 permits vertical adjustment of the plate 314 and the keyboard support assembly 400 in a single handed motion vertically by moving the lever 398 downwardly, which in turn moves the rod 385 and its actuator trigger 384 and opens the valve 382 of the gas spring cylinder 372. Once the valve 382 is opened, the carriage assembly 350 can be slid upward or downward on the track extrusion 328. To lock the carriage assembly 350 in a desired position, the lever 398 is simply released and valve 382 is closed by the actuator trigger 384.

It should be understood that the rigid materials used in the manufacture of the adjustable support bracket 310 unless specifically identified can be aluminum or other suitably rigid materials such as other metals or plastics.

While this disclosure describes preferred example embodiments, it is understood that the designs may be further modified or adapted while still practicing the general principles of the invention. The claims are not limited to the preferred embodiments and have been written to preclude such a narrow construction using the principles of claim differentiation.

I claim:

1. An adjustable support bracket for mounting a device, comprising:
a vertically elongated support track having a plurality of parallel channels extending vertically;
a carriage assembly having a support surface and channel engaging members wherein said carriage assembly is retained by and slidable along said channels;
an actuator assembly comprising a gas spring assembly that includes a valve, wherein said gas spring assembly releasably retains said carriage assembly at desired locations along said support track; and
said actuator assembly further comprises a lever that is connected to a rod having an actuator trigger operatively connected to the valve of said gas spring assembly, wherein the lever is movable to open and close said valve.

2. The adjustable support system as set forth in claim 1, wherein:
said gas spring assembly includes a gas spring cylinder having first and second ends;
said first end of said gas spring cylinder being connected to said support track; and
said second end of said gas spring cylinder being connected to said carriage assembly.

3. The adjustable support system as set forth in claim 1, wherein said carriage assembly includes a keyboard support.

4. The adjustable support system as set forth in claim 1, wherein said carriage assembly includes a mounting plate.

5. The adjustable support system as set forth in claim 2, wherein said actuator assembly further comprises:
an actuator trigger block connected to an actuator lever chassis; and
said actuator trigger is slidably received by said actuator trigger block.

6. The adjustable support system as set forth in claim 1, wherein:
said actuator lever is pivotally connected to the rod and to an actuator lever chassis; and
said actuator lever chassis is connected to said carriage assembly.

7. The adjustable support system as set forth in claim 1, wherein said support track is configured to be connected to a vertical support surface and further comprises a front wall wherein said gas spring assembly further comprises a gas spring cylinder that is disposed between said front wall of said support track and said vertical support surface.

8. The adjustable support system as set forth in claim 7, wherein the support track further comprises a tube and said gas cylinder is disposed within the tube.

9. The adjustable support system as set forth in claim 1, further comprising a vertically elongated mounting bracket being configured to be connected to said vertical support surface and to said support track.

10. The adjustable support system as set forth in claim 1, wherein a keyboard support assembly is pivotally connected to said carriage assembly.

11. The adjustable support system as set forth in claim 10, wherein the keyboard support assembly further comprises:
a base member connected to said carriage assembly; and
a keyboard plate pivotally connected to the base member and being biased by a spring to fold upward when not in use.

12. The adjustable support system as set forth in claim 1, wherein said carriage assembly includes bushings that engage said channels.

13. The adjustable support system as set forth in claim 1, wherein said carriage assembly includes a support plate configured to support a computer monitor

14. A height-adjustable support system, comprising;
a vertically elongated support track having a top end and a bottom end and a plurality of parallel channels extending between said top end and said bottom end;
a carriage assembly having a support surface and channel engaging members wherein said channel engaging members of said carriage assembly are retained by and slidable along said channels of said support track;
said carriage assembly including a support plate spaced apart from and being positioned above a keyboard support;
an actuator assembly comprising a movable rod having an actuator trigger at one end and being pivotally connected to an actuator lever at an opposed end;
the actuator trigger being connected to a valve of a gas spring assembly that is connected at a first end to said support track and at a second end to said carriage assembly; and
wherein said actuator assembly releasably retains said carriage assembly at positions along said support track.

15. The height-adjustable support system as set forth in claim 14, wherein said actuator lever is pivotally connected to said rod and to an actuator lever chassis.

16. The height-adjustable support system as set forth in claim 15, wherein said actuator lever chassis is connected to said carriage assembly and said lever extends outwardly therefrom.

17. The height-adjustable support system as set forth in claim 16, wherein said actuator assembly further comprises an actuator trigger block that is connected to said lever chassis and extends rearward through a slot formed through a front wall of said vertically elongated support track and is connected to said gas spring assembly.

18. The height-adjustable support system as set forth in claim 17, wherein said actuator trigger block slidably receives said actuator trigger.

19. The adjustable support system as set forth in claim 14, wherein the keyboard support assembly further comprises:
a base member connected to said carriage assembly; and
a keyboard plate pivotally connected to the base member and being biased by a spring to fold upward when not in use.

20. The adjustable support system as set forth in claim 1, wherein said carriage assembly includes bushings that engage said channels.
